(19) United States
(12) Patent Application Publication
(10) Pub. No.: US 2012/0121371 A1
(43) Pub. Date: May 17, 2012

(54) DEVICE FOR PARTICLE FREE HANDLING OF SUBSTRATES

(75) Inventors: Martin Aenis, Darmstadt (DE); Christof Klesen, Modautal (DE); Ulrich Oldendorf, Ober-Ramstadt (DE); Thomas Sebald, Darmstadt (DE)

(73) Assignee: SEMILEV GMBH, Grosswallstadt (DE)

(21) Appl. No.: 13/266,648

(22) PCT Filed: May 26, 2010
(86) PCT No.: PCT/EP2010/057236

§ 371 Date: Dec. 15, 2011

(30) Foreign Application Priority Data
May 28, 2009 (DE) 10 2009 022 987.6
Aug. 27, 2009 (DE) 10 2009 038 756.0

(51) Int. Cl. B65G 47/74

(52) U.S. Cl. 414/749.2

(57) ABSTRACT

A device for particle free handling of substrates of micro technology within mini environments under clean room conditions works friction free and thus particle free. One component of the device is movable relative to an other component in at least the x-, y-, z-axes and a Φ-direction and supported and driven along each of the axes and the direction contactless electromagnetically. Transmission of energy for bearing and driving the one component is effected contactless. The device includes at least one active component and at least one passive component. A movable active component may be guided on the fixed passive component by a magnet bearing, and a drive motor which rides with the active component may be coupled with an energy supply over an electromagnetic coupling.

The invention is concerned with a device for particle free handling of substrates according of micro technology within mini environments under clean room conditions, especially for handling of silicon wafers in the semiconductor industry.

Since the application of the SMIF technology (Standard Mechanical Interface) for the handling of 200 min wafers in the earlier ninteties were silicon wafer in manufacturing of semiconductors no longer handled by persons but by robots. Thus each manufacturing machine is equipped with a so called factory interface respectively an EFEM (Equipment Front-End Module) which is arranged to open the transport cassettes with the wafers inside—“SMIF-pods for 200 mm and “FOUPS” (Front Opening Unified Pod)—at the machine, withdrawing the wafer and positioning of it within the production machine.

Thus the EFEM's underlie the highest purity standard like each production machine. In case of the 200 mm technology the design of the EFEM's was free selectable for the machine manufacturers, only the SMIF ports, this is the opening mechanism (SMIF loader) for the cassettes, was defined by the organisation SEMI (semi.org) and standardized worldwide. The used robotics and the design of the clean room engineering in the hand-over area between SMIF loader and machine access was something poorly conceived and was not in accordance with the necessary purity standard of the respective semiconductor technology.

Procedures for measuring and acceptance in view of the pureness of such small EFEM clean rooms, so called mini environments, was codified from SEMI in a standard “SEMI E44” in 1995 and 1996 to facilitate the manufacturers of machines to define the pureness of such systems.

Based on the experience in the SMIF technology the organisation SEMATECH (permatech.org) has published a guideline for the design of EFEM's (#99033693A-ENG, “Integrated Mini Environment Design Best Practices”) with the initiation of 300 mm wafers in March 1999.

The construction of handling robots within the mini environments was not regulated in this documentation. Typically the robots are called also as handler. These are constructions for handling of silicon wafer with four degrees of freedom (linear x-, y-, z-axis and a rotational movement around the z-axis, the Φ-direction) which are used in such mini environments. Newly robots are used with a plurality of rotational axis because of the reason of the used area.

The robots are provided with bearings or slide bearings typically. The long linear movements at the base of the mini environment (typically called as y axis) pass mostly on conventional rolls or ball circular bearings and are driven by drive belts, steering racks or linear motors in best case.

The energy supply of such systems as well as signal cables and vacuum hoses if necessary must be carried by cables over drag chains respective energy cable drag chains.

All these mechanical components generate particles because of the friction which is not avoidable. In actual systems it is tried to keep off the generated particles from the critical wafer surface over a vertical movement of the air and exhaustion and encapsulation. Due to the turbulence and the “chaotic” behaviour of moved airflow at moved systems the effectiveness of such methods are limited in general. I.e. some parts of the generated particles reach the surface of the wafer at statistical view always.

With advanced miniaturization of structures and the enhancement of complexity of functions on the silicon wafer and especially with the next bigger wafer diameter of 450 mm the requirements in view of the pureness will be absolutely stronger. SEMATECH suggests in ITRS (International Technology Roadmap for Semiconductors) a refinement of the air quality at an ISP class 1 (ISO Standard #14644).

The JP 04264749 discloses a transport robot at which the wafers are transported in a carriage through a tunnel by magnetic force whereby the carriage impends in the tunnel or impends below a handling device held by magnetic force. The transfer of the wafer into several transport roadways is handled by a transport robot. A similar transport system for wafers is described in the EP 0 626 724 B1.

The U.S. Pat. No. 6,045,319 B and EP 0 246 098 B1 discloses also a magnetic transport system for the impending transport of carriages which can carry several articles. But there exist some additional guiding elements which can generate particles.

For the handling of wafers in such transport systems are used handlers for the handling of the wafers which realize a transport of the wafer in x-, y-, z- and Φ-direction.

In the JP 04267355 A is disclosed a wafer transport robot which can transport wafers in a vacuum chamber by a robot which is driven by magnets which are positioned outside the vacuum chamber.

In the U.S. Pat. No. 5,288,199 is described a fixed positioned wafer handler which is provided with a magnetic drive for the linear movement. For that purpose the working arm is provided with a fork at one end which is moved in axial direction by an electromagnet. The pivotal bearing of the wafer handler is carried out conventional.

It is a task of the invention to provide a device for particle free handling of substrates of micro technology which works friction free.

The task is solved by a device according the invention which is designed with several degrees of freedom whereby at least the x-, y-, z- and Φ-direction is carried and/or guided magnetic and contact free, whereby the bearing and driving of each of the axis is effected contact less electromagnetic and the transmission of energy for bearing and driving is effected contact less and at least one active component and at least one passive component is designed.

The magnet bearings are designed as electromagnetic, electro dynamic or permanent magnetic bearings, whereby the energy is transferred by induction or by transformer.

Each axis is provided with position sensors which transfer the sensor data contact less, whereby the sensor data are transferred wireless.

The actuating elements are fixed in general and a transport unit is moved by actuating elements contact less, whereby the actuating elements ride with the transport unit.

A movable active unit is guided hanging over a magnetic bearing on the fix standing passive component, whereby a drive motor, disposed at the active component, is connected with an energy supply over a coupling unit and at the active component is disposed a lift-rotary unit with a handler.

The lift-rotary unit is provided with an outer tube which is fixed standing on the active component, within one ore more levels are at least three magnet bearings disposed regular on the inner surface to guide an inner tube contact less and in vertical direction between two end positions.

Within the inner tube is disposed a central lift motor which is connected functional with a bar which is fixed standing within the inner tube.

Within the inner tube is disposed an electromagnetic rotary drive also to effect a controllable rotation of the inner tube adverse to the fixed standing bar.

At the handler is disposed an electromagnetic movable fork to support a silicon wafer.

According the invention comprise the frictionless the mechanical bearing of the several components as well as the energy and signal transmission to the several components.

The invention will be described on an example hereinafter. The respective drawings illustrate in

FIG. 1: a device according to the invention for particle free handling of substrates depicted in a cross section transverse to the driving direction with a fixed passive component, the active component is moved within the passive component whereby the good with the silicon wafers to be transported resides in the active component;

FIG. 2: a schematic side view of the device according FIG. 1 with the active component being in movement through the passive component;

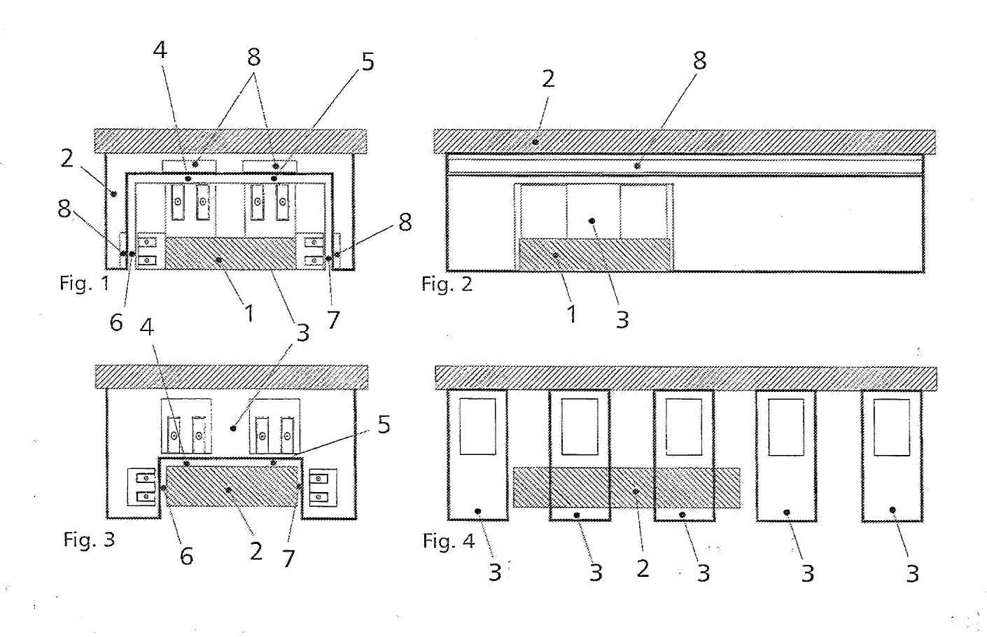

FIG. 3: a device according to the invention for the particle free handling of substrates with standing active component shown in a sectional view transverse to the driving direction with moved passive component whereby the good with the silicon wafers to be transported resides in the passive component;

FIG. 4: a schematic depiction of the device according FIG. 3 with a passive component driving through active components being disposed with interspace;

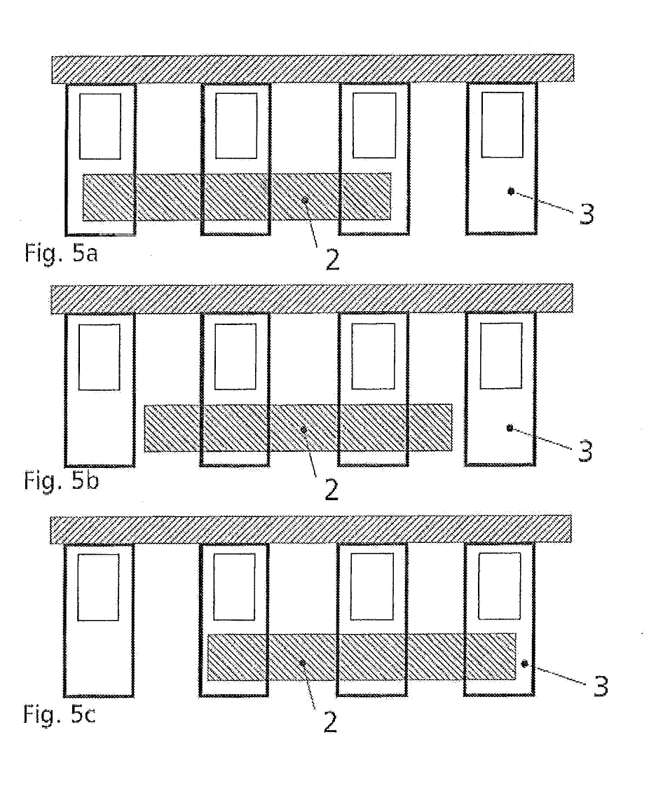

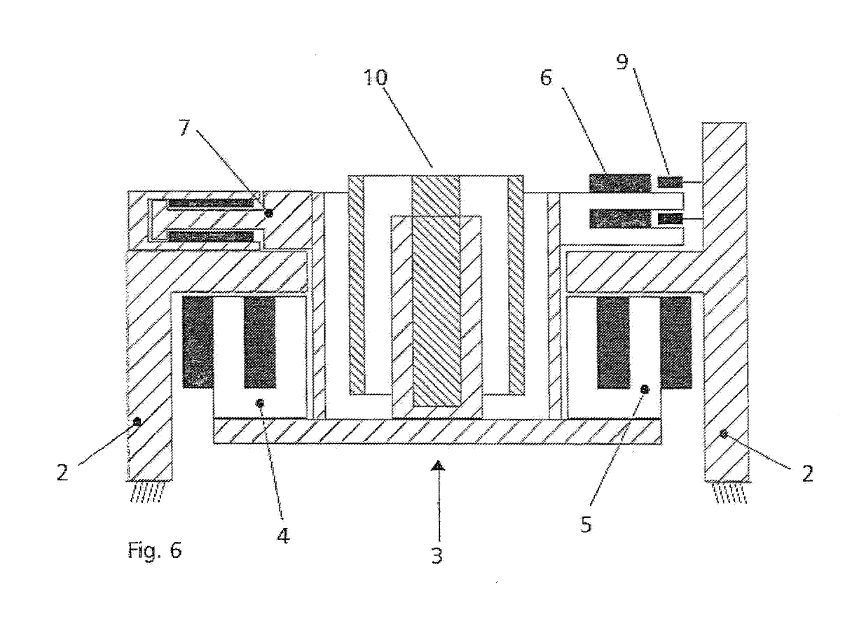

FIG. 5a-c: the passive component during the run through active components in several positions;

FIG. 6: a sectional view of an electromagnetic linear-bearing as well as to drive a passive component within an active component according the invention;

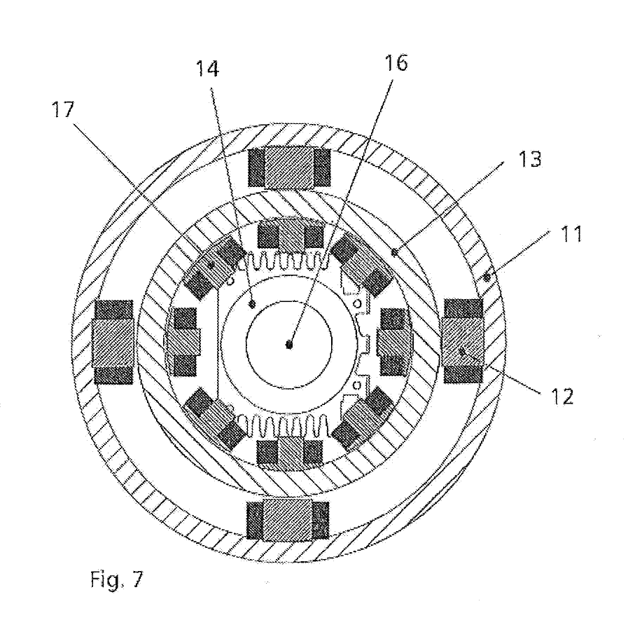

FIG. 7: a sectional view of an electromagnetic lift-rotary bearing according the invention;

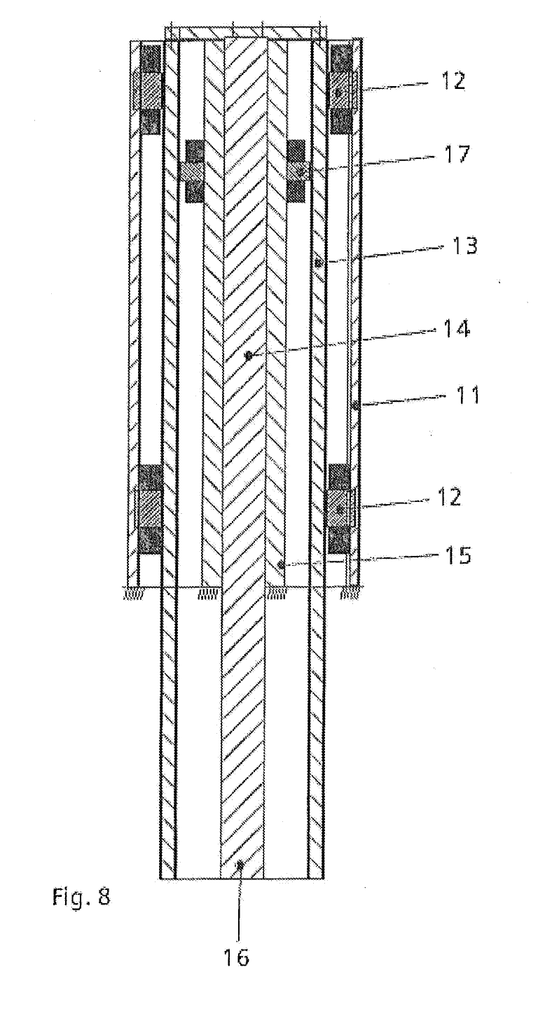

FIG. 8: a sectional side view of the lift-rotary bearing of FIG. 7 according the invention;

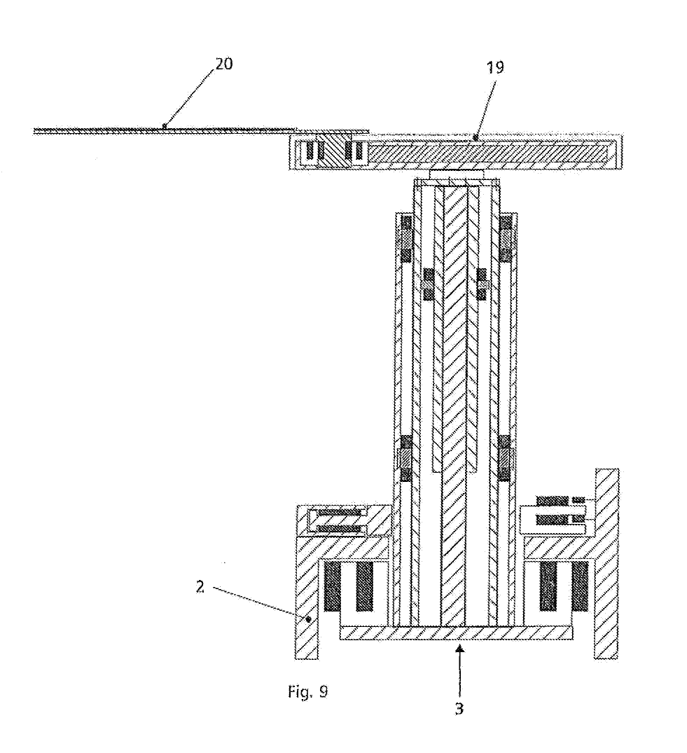

FIG. 9: a schematic sectional depiction of combination of a linear bearing and a rotary bearing with attached handler for silicon wafers in a lower position with a handler which is moved out;

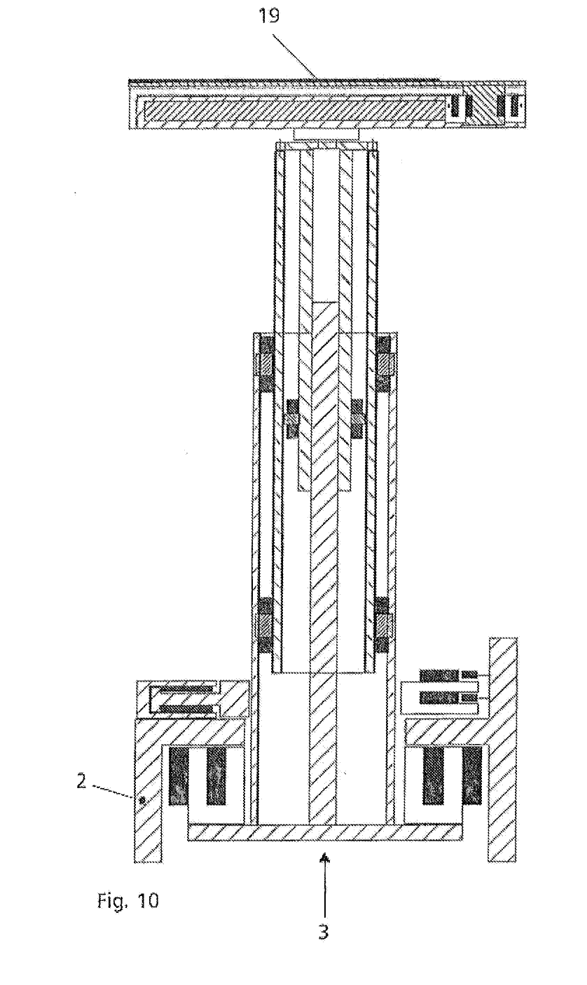

FIG. 10: the device according to FIG. 9 with moved in handler in an upper position;

FIG. 11: details of the handler according to FIG. 10 with magnetic bearing and electromagnetic drive;

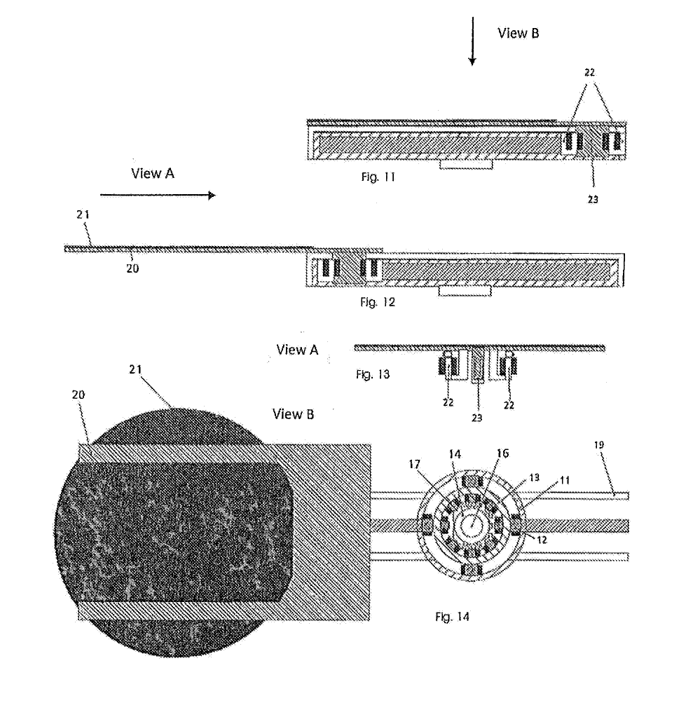

FIG. 12: the handler according to FIG. 11 in moved out position;

FIG. 13: a sectional view of the handler according view A of FIG. 12; and

FIG. 14: the view B of the handler according to FIG. 12.

FIG. 1 illustrates a device for particle free handling of substrates (not shown) or other goods to be transported within a container 1 according the invention, which shows a sectional view transverse to the drive direction. The device consists of a fixed passive component 2, an active component 3 movable by magnetic force within along a planned trackway. Since the active component is moved it is necessary to provide it with energy for the magnetic bearing 4, 5 which held the active component below the passive component levitating. The energy supply is realized by an electromagnetic coupling device 6 which also powers the drive motor 7 with energy which is designed as a linear induction motor. The passive component 2 is provided with permanent magnets 8 only.

FIG. 2 illustrates the active component 3 during the drive along the passive component 2.

In FIG. 3 is shown a fixed active component 2 with moved passive component 2. The good with the silicon wafers to be transported resides in the transport container 1 which is the passive component 3 at the same time. To realize a drive of the passive component 2 in this embodiment, there are disposed some active components 2 disposed with interspace to one another along the planned trackway. FIG. 4 depicts a passive component 2 during the drive through some active components 3.

To guarantee a safe guiding of the passive component 2 it is to ensure that it will be held in abeyance always by at least two active components 3 during the drive (FIG. 5a-c).

FIG. 6 shows a detailed sectional view of an electromagnetic linear bearing with an active component 3 supported in a passive component 2 according the invention.

To transfer energy to the active component there is arranged on the active component 3 an electromagnetic coupling device 6 vis-à-vis to fixed coils 9 at the passive component which are used as transmitting antenna. Furthermore there are disposed two lateral fastened magnetic bearings 4, 5 which held the active component 3 on the passive component 2 in balance and in abeyance.

The drive of the active component 3 is realized over the drive motor 7 arranged on it which is designed as a linear motor.

Furthermore the active component 3 is provided with a lift-rotary unit 10.

FIGS. 7, 8 depict sectional views of such a lift-rotary unit. This lift-rotary unit comprises e.g. an outer tube 11 fixed standing on the active component 3 (FIG. 3) with four magnetic bearings 12 at the inner circumferential surface within one ore more levels disposed with an angular offset of each 90° between them to bear an inner tube 13 without contact in vertical direction and which is movable supported between two end positions.

To move the inner tube 13 in vertical direction is disposed a central lift motor 14 within of it with a fixed standing coil arrangement 15 and also a magnetisable bar 16 vertical disposable within the tube 13. The upper free end 18 of the inner tube 13 is used to hold further components like a handler 19 to hold and transport of wafers.

Furthermore is arranged a rotary drive 17 within the inner tube 13 (FIG. 7).

FIG. 9 shows a combination of a linear and rotary supported according FIG. 7 with a attached handler 19 which is provided with an electromagnetic disposable fork 20 for carrying a silicon wafer 21 (FIG. 14). In FIG. 9 is the handler 19 shown with driven out fork 20 in a lower end position and in FIG. 10 in an upper end position with retracted fork 20. The handler 19 is also equipped with a contact free bearing and drive.

Details of the handler 19 are shown in FIG. 11-14, FIG. 11 shows the handler 19 according FIG. 10 with a magnetic bearing 22 and an electromagnetic drive 23 with retracted fork 20 (FIG. 11) and with pulled out fork 20 (FIG. 12).

FIG. 13 depicts a sectional view of the handler in a view A according FIG. 12 with a magnetic bearing 22 and the electromagnetic drive 23.

FIG. 14 depicts a view B of the handler according FIG. 12 with retracted fork 20 as well as the rotary drive according FIG. 7.

### DEVICE FOR PARTICLE FREE HANDLING OF SUBSTRATES

### LIST OF REFERENCE NUMBERS

1 transport container
2 passive component
3 active component
4 magnetic bearing
5 magnetic bearing
6 electromagnetic coupling device
7 drive motor
8 permanent magnet
9 coil
10 lift unit
11 outer tube
12 magnetic bearing
13 inner tube
14 lift motor
15 coil arrangement
16 magnetizable bar
17 rotary drive
18 free end
19 handler
20 fork
21 silicon wafer
22 magnetic bearing
23 electromagnetic drive

1. Device for particle free handling of substrates of micro technology within mini environments under clean room conditions, comprising at least one active component and at least one passive component, one component being mounted for movement relative to an other component in at least the x-, y-, z-axes and a Φ-direction, wherein the one component is supported and driven along each of the axes and the direction contact-less electromagnetically, and transmission of energy for supporting and driving the one component is effected contact-less.

2. Device according to claim 1, wherein the at least one active component comprises electromagnetic, electro dynamic or permanent magnetic bearings.

3. Device according to claim 1, wherein the energy is transmitted by induction or by transformer.

4. Device according to claim 1, wherein the axes are provided with position sensors which transfer sensor data contact-less.

5. Device according to claim 4, wherein the sensor data is transmitted wireless.

6. Device according to claim 1, wherein the at least one active component is fixed and the transport at least one passive component is moved by the at least one active component contact-less.

7. Device according to claim 1, wherein the at least one passive component is fixed and the one active component moves relative to the at least one passive component.

8. Device according claim 7, wherein the at least one active component is guided by a magnetic bearing on the fixed at least one passive component, and further comprising a drive motor disposed at the at least one active component and connected with an energy supply over a coupling unit, and wherein the at least one active component includes a lift-rotary unit with a handler.

9. Device according to claim 8, wherein the lift-rotary unit includes an outer tube fixed standing on the at least one active component and magnetic bearings disposed on an inner surface of the outer tube to guide an inner tube contact less and in vertical direction between two end positions.

10. Device according to claim 9, wherein the lift-rotary unit further comprises a central lift motor within the inner tube connected with a bar which is fixed standing within the inner tube.

11. Device according to claim 10, wherein the lift-rotary unit further comprises an electromagnetic rotary drive within the inner tube to effect a controllable rotation of the inner tube adverse to the fixed standing bar.

12. Device according to claim 8, wherein an electromagnetic movable fork is disposed at the handler to support a silicon wafer.
